(19) United States
(12) Patent Application Publication
(10) Pub. No.: US 2006/0060685 A1
(43) Pub. Date: Mar. 23, 2006

(54) Grinder pump system

(75) Inventors: Mark P. Kowalak, Troy, OH (US); Peter J. Jazenski III, Hubert Heights, OH (US); Kirk W. Neer, Sidney, OH (US)

Correspondence Address: STANDLEY LAW GROUP LLP, 495 METRO PLACE SOUTH, SUITE 210, DUBLIN, OH, 43017, US

(73) Assignee: Crane Pumps

(21) Appl. No.: 10/943,727

(22) Filed: Sep. 17, 2004

(51) Int. Cl. B02C 23/36

(52) U.S. Cl. 241/46.017

(57) ABSTRACT

A grinder pump system that is simpler to install, and permits ready access to the pump system components, has a grinder pump station for receiving a grinder pump. The pump station has a basin with an interior volume to provide a well for receiving sewage. A sewage inlet port and a sewage discharge port allow, sewage to flow into and out of the basin interior volume. The basin is positioned below grade, and sewage is directed thereto through a sewage source. An access riser is selectively coupled to the basin, and extends to the ground surface. Pump system components mounted within the basin are accessible via the access riser and an opening on the basin top surface. A lid assembly is selectively removably coupled to the access riser to close the system from the environment.

The present invention relates to a grinder pump system and station for use in association with a low-pressure sewage operation in which sewage is collected in a basin and boosted from the basin by a grinder pump.

### BACKGROUND OF THE ART

Today, low-pressure sewer systems, incorporating grinder pumps, are a desired alternative to conventional gravity sewer systems and septic tank use. Sewage grinder pump systems are now a widely accepted and popular means for handling residential waste, where conventional gravity sewer systems may not be practicable, or are expensive, requiring high priced materials and significant labor. Environmental concerns have also forced many communities to seek alternatives to both conventional gravity sewer systems and septic tank use. By keeping costs at a minimum and providing effective wastewater storage, conditioning, and transport, grinder pump systems provide a rational and cost effective alternative to conventional wastewater management systems.

In situations where a grinder pump system is needed, the installation of the system remains a significant component of the overall cost of a sewage grinder pump system. Prior to installation of a grinder pump, an engineer or surveyor will typically determine the location for placement of the grinder pump station, and the location is excavated to place the station within the ground, but accessible for repair or maintenance. Prior grinder pump systems have been formed with a housing for holding the pump and associated equipment, as well as for holding and processing an amount of wastewater, wherein the housing is dimensioned to be placed in the ground with a top cover accessible at approximately ground level. In some situations, during excavation for positioning of the grinder pump station, obstructions may be encountered in the field, e.g., a bed of rocks, etc., which may then require more excavation and the associated costs, adding to the overall cost of the installation. An alternative to additional excavation is modification of the height of the grinder pump station in the field. In many of the prior applications for grinder pump stations, the field adjustment of the height of the pump station has proven to be a difficulty.

Another difficulty encountered in the field is the access to the grinder pump in the pump station. In many prior systems, the pump housing or station is designed to allow direct access to the pump and other components in the housing while the station is in the ground. If the grinder pump system has a housing or station with a large diameter access opening, especially one that permits direct access to the grinder pump, the access port may be an unsightly addition to a user's yard or property. However, small diameter access openings pose the difficulty of limiting access to the grinder pump. Since one frequently cited reason for not using a grinder pump in a residential setting has been the high maintenance requirements, difficulty in access to the pump for repair or replacement exacerbates that problem and results in a sub-optimal sewage system. It would be desirable to provide a grinder pump system that allows for simplified access to the pump and other components of the system.

It is also noted in the prior grinder pump systems, that the pump housing or station is formed in a manner that makes it difficult to adequately process and eliminate all wastewater or effluent entering the system. The pump housing has typically been shaped as a cylindrical basin in which the grinder pump is mounted, forming a closed cylindrical space in which wastewater or effluent is processed and pumped from. The shape of the pump housing makes it difficult to process or grind up the complete contents in the housing, resulting in possible problems and maintenance requirements. The housing walls may also become coated with residue, ultimately adversely effecting proper operation of the system.

Thus, a need exists for a grinder pump system which possesses improved structural integrity and operation, enjoys simple installation, allows field height modification in small increments without interfering with electrical and ventilation interfaces, and permits ready access to internal station components.

### SUMMARY OF THE INVENTION

The invention is thus directed to a grinder pump system which overcomes the limitations of prior designs, and provides a robust system which is simpler to install, allows field adjustment for installation and permits ready access to the pump system components. The system generally comprises a grinder pump station for receiving a grinder pump, wherein the pump station comprises a basin with an interior volume to receive sewage. The basin includes a sewage inlet port and a sewage discharge port, allowing sewage to flow into and out of the basin interior volume, respectively. The basin is designed for positioning within the ground, and sewage is directed thereto through a conduit from a plumbing system. An access riser is selectively coupled to the basin, and extends to the ground surface. Pump system components mounted within the basin are then accessible via the access riser and an opening on the basin top surface. A lid assembly is selectively removably coupled to the access riser to protect the system components from the external environment. In an embodiment, a grinder pump is provided in association with a modular system, which is removably coupled to the basin, thereby allowing the entire pump and related components to be easily removed from the basin for maintenance or repair. The objects of the invention are achieved by a device as described in more detail below and as shown in the drawings, in conjunction with an embodiment thereof.

### BRIEF DESCRIPTION OF THE DRAWINGS

Better understanding of the present invention will be had by reference to the accompanying drawings, wherein identical parts are identified by identical reference numerals and wherein:

FIG. 1 is a side view of an embodiment of the grinder pump system according to the invention.

FIG. 1A is a cross sectional view of the system as shown in FIG. 1.

FIG. 1B is a partial cross sectional view of the system shown in FIG. 1.

FIG. 2 is a top view of the embodiment shown in FIG. 1.

FIG. 3 is an exploded view of the embodiment shown in FIG. 1.

FIG. 4 is a partial, enlarged view of a portion of the discharge outlet shown in the region D of FIG. 1.

FIG. 5 is a partial, enlarged view of a portion of the discharge outlet shown in the region E of FIG. 1.

FIG. 6 is a partial, enlarged view of the interface between the pump-orienting device and basin shown in region C of FIG. 1.

FIG. 7 is a partial, enlarged view of the interface between the pump-orienting device and basin shown in region B of FIG. 1.

FIG. 8 is a partial, enlarged view of the interface between the pump-orienting device and pump shown in region G of FIG. 1.

FIG. 9 is a partial, enlarged view of the interface between the upper and lower basin sections shown in region H of FIG. 1.

FIG. 10 is a perspective view of the cap assembly shown in the embodiment of FIG. 1.

### DESCRIPTION OF THE INVENTION

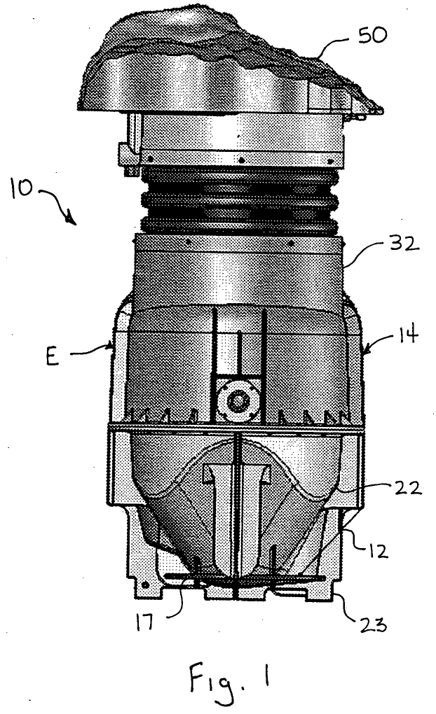

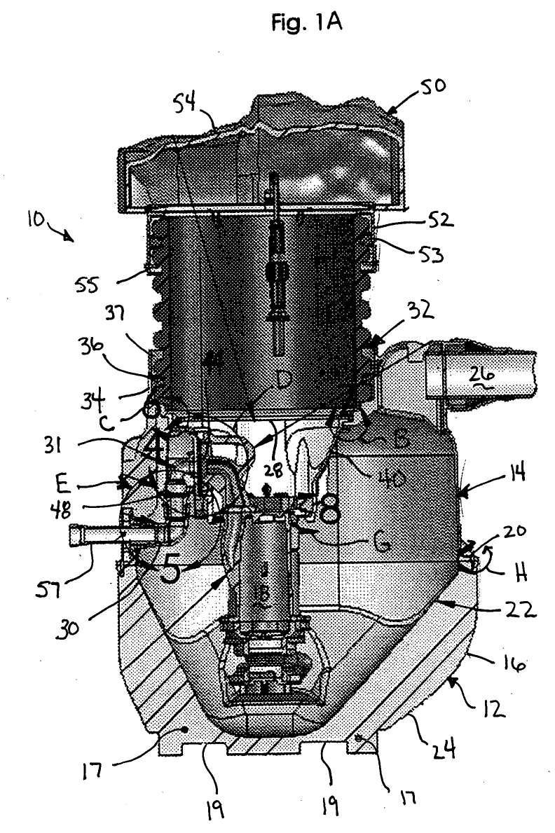

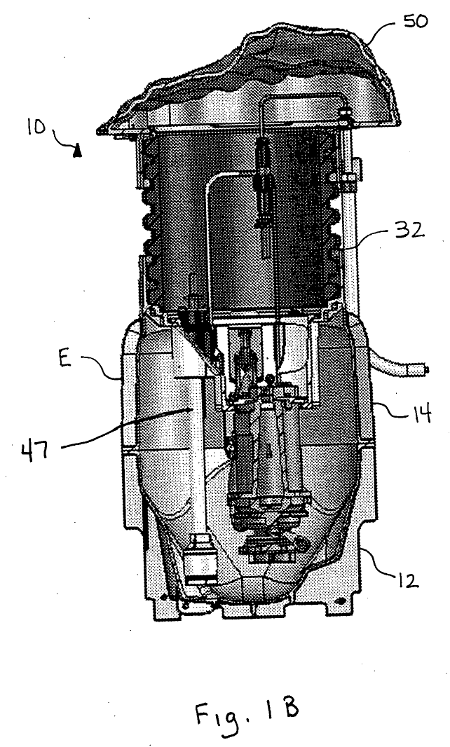

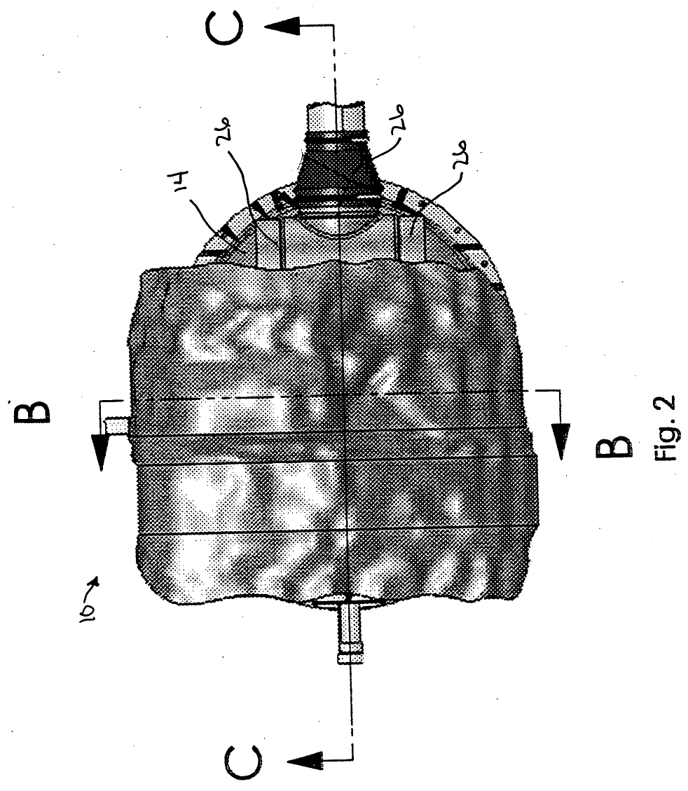

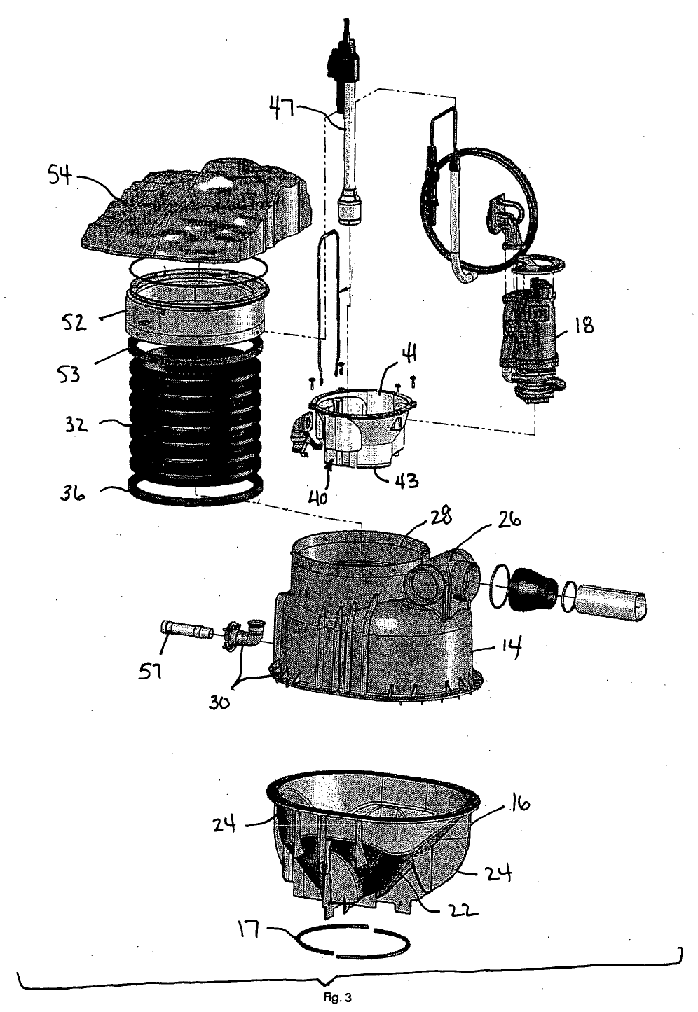

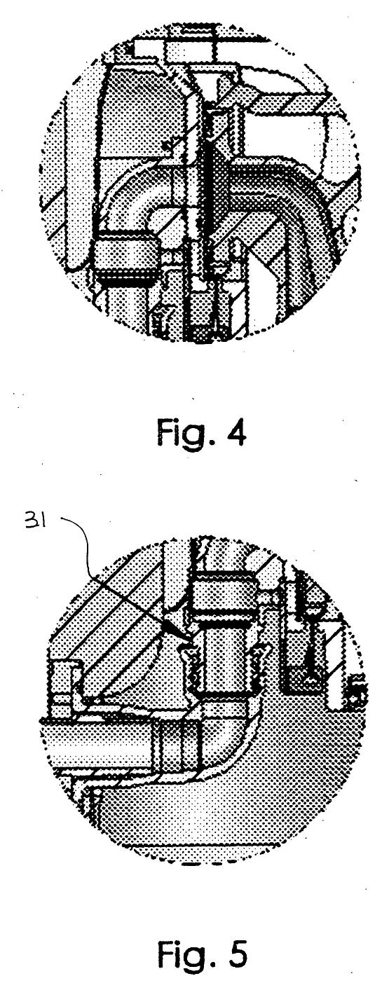

Turning now to FIGS. 1-3, an embodiment of the invention is shown which relates to a grinder pump system and grinder pump station of the present invention. The grinder pump system 10 includes a basin 12, which may be comprised of sections 14 and 16. The sections 14 and 16 are connected to one another to define an internal volume that serves as a volume for receiving sewage or effluent from a plumbing system. The grinder pump system 10 is designed to boost the sewage by a grinder pump 18, from the system 10 under pressure and in a suspended slurry that is maintained in suspension by its velocity. In this embodiment, the basin 12, and upper and a lower portions 14 and 16 respectively, may be previously constructed and provided as a single basin unit for subsequent positioning at the field installation site. Alternatively, the basin could be constructed at the installation site or could be provided as a one-piece, integral unit if desired. The upper and lower portions 14 and 16 have mating flanged surfaces 20 that may be joined by screws or other suitable fasteners (not shown), and a sealant may be provided in association with the flanged surfaces to prevent leakage from the basin 12. As an example, the flanged surfaces 20 may be provided with v-grooves and corresponding projections 21 (see FIG. 9) in which a sealant is retained, or other suitable sealing structures are contemplated, such as the use of a compressible gasket to seal the joint between sections 14 and 16 against leakage.

As seen in FIGS. 1, 1A and 1B, the basin 12 of the present invention has a sloped internal wall 22 in the basin lower portion 16, so that the basin has an increasing cross-sectional area as the height from the bottom surface of the interior volume increases. This sloping internal wall 22 provides several advantages. In some known devices, the grinder pump station housing is formed as a cylindrical tank, which is set in the field location with its axis aligned vertically. Such a grinder pump station provides a cylindrical wet well with an essentially constant cross-sectional area. Since the sewage will typically flow into such a tank through the side wall or, at least, near the side wall, the solids contained in the sewage will tend to drop out of the sewage liquid and can accumulate near the wall of the station, near the bottom of the station. Even with an axially positioned grinder pump inlet, such a cylindrical tank allows these solids to amass at the bottom of the tank, as the solids are not effectively moved radially (or laterally) near the tank bottom. If sewage solids accumulate in the basin without being routinely discharged, the basin is acting as a septic tank, a function for which it is clearly not designed or intended. By way of contrast, the sloping internal wall 22 of the basin 12 in the present invention provides two means of directing the solids in the sewage to the grinder pump inlet. The first of these is the wall itself. If solids drop out from the liquid, they can slide down the wall to the bottom, where the entire bottom surface of the basin 12 will be relatively proximate to the grinder pump inlet. Further, the decreasing cross-sectional area toward the bottom of the basin 12 means that the space velocity, that is the volume of flow per unit of cross-sectional area and time, of the sewage mixture will increase as it flows through the constricting available cross-sectional area as it nears the basin bottom. This increasing space velocity assists in maintaining the solids in suspension until they can be macerated in the grinder pump, and pumped out of the station.

It will be noted that the sloping internal wall 22 can be achieved through a variety of geometries. In one embodiment, for instance, the slope of wall 22 can increase linearly, to result in an inverted frustoconical shape. In another embodiment, the rate of change of the slope can change as the height above the basin bottom increases, providing a dished-out or arcuate internal wall 22.

This sloped internal wall 22 provides even additional advantages over the cylindrical tanks known in the prior art. First, the increase in cross-sectional area as a function of height (as opposed to an essentially constant cross-sectional area in a cylindrical tank) means that the addition of a fixed volume of sewage causes a smaller change in the height of the sewage liquid level when the liquid level is higher than it does when the liquid level is lower. As a practical operational consideration, this means that the grinder pump station of the present invention can accommodate additional sewage during an upset condition when the liquid level in the basin 12 is already high, as compared to a conventional cylindrical tank.

The basin 12 may also be provided with engineered gussets 24, formed on the bottom portion 16, which are optimized to provide desired structural integrity. The gussets 24 are designed and located to accommodate expected or different loads to which the basin 12 may be subjected. The gussets 24 also may facilitate maintaining the basin 12 in the installed position within the ground, as they typically will be encompassed within a base of concrete poured around the bottom of basin portion 16. Alternatively, the basin 12 can be filled around with soil, including between the gussets 24, to stabilize and anchor this section in the ground. The shape and construction of the bottom portion 16 of basin 12 provide sufficient support to accommodate expected loads, without the use of a concrete footer, as is used in some prior systems.

Additionally, the basin portion 16 may be formed with integral features to facilitate handling as well as positioning. The basin portion 16 may have integral openings 17 to house rebar 58 for maintaining the position of the basin 12 within a formed well. Generally, the basin 12 is placed in a well, and concrete is poured around the basin portion 16 to fix it in position, and resist movement of the basin 12 thereafter. This firmly installs the system in a desired location and provides an anti-flotation configuration to avoid possible floatation in the event of flooding or the like. The rebar 58 integrated into association with the portion 16 may be half circle configurations that are positioned with portion 16 via the holes 17. The rebar 58 extends around the basin 12 at a lower portion thereof, and will be covered by the concrete poured into the hole, to fix and maintain its' position.

To facilitate handling of the system 10, the basin portion 16 may also have features to allow handling via a tow motor or forklift. The basin portion 16 may be formed with integral slots 19 for lifting by the forks of a tow motor. Alternatively, or in conjunction, outwardly extending bosses 21 may be formed to allow lifting of the system by a forklift.

The portions 14 and 16 of basin 12 may be molded with these integral features, such as for example by injection molding techniques. This also allows integral features to be incorporated for shipping and storage purposes, such as for stacking of a plurality of basins 12 with one another. For example, the bottom portion 16 may have integrally formed therein, a bottom nesting portion 23, which mates with the top opening 28 of the upper portion 14, to allow stacking therewith.

The upper portion 14 of the basin 12 provides the desired tank volume in conjunction with the lower portion 16, and further provides for simple and effective mounting of other components, as will be described in more detail hereafter. The upper portion 14 also provides access and egress from the basin 12. The upper basin portion may be provided with openings for connection to and mounting of different systems. An opening 26 is provided as a sewage inlet port, which is selectively coupled to a conduit of a sewage plumbing system, such as in a residence or other facility. The section 14 may also have a top opening 28, for providing access to the basin 12, and for mounting and positioning of other components in association therewith. The opening 28 of this embodiment, as will be described below, is preferably adapted to receive and retain a device for orienting a pump, preferably a grinder pump, in the basin 12, formed by the upper and lower sections 14 and 16. A third opening 30 in the upper portion 14 provides a pressurized sewage discharge outlet, preferably, as shown in the illustrations, positioned on a side surface of the upper portion 14.

The particular embodiment illustrated in the accompanying figures shows the sewage inlet port opening 26 with a sewage inlet fitting seated therein. The particular sewage inlet fitting may have multiple ports, such as three available ports, one of which is selected at the field installation site to be fitted to the sewage source pipe. The sewage inlet fitting may have these three inlet ports located at 90° angular intervals, so that the first and third ports are 180° opposed from each other. This arrangement provides the ability to connect to the sewage source pipe with a minimum amount of field piping. Prior to installation, the plurality of possible inlet ports 26 are provided with a barrier, such as a wall, over the port. At the time of field installation, the proper inlet port 26 may be selected and an opening may be established in the selected inlet port 26, such as by drilling out the wall in the opening, thereby rendering it useful while keeping the other inlet ports unopened.

The third opening 30 in the basin upper portion 14 permits the discharge of macerated sewage under pressure from the interior of the basin 12 to the exterior, where it will be communicated to the sanitary sewage system. Removably fitted in this third opening are shut-off valve 31 and a sewage discharge pipe 56 that is removably affixed to the discharge side of the pump 18, internal to the basin 12. The ball valve 31 is conveniently integrated into the system of the pump orienting device 40 to be described below. Because it receives pressurized fluid, the sewage discharge pipe 56 should be located in close proximity to the pump 18, and desirably provides a generally horizontal exit from the basin 12. The preferred location for this third opening 30 is in the side surface of the basin, rather than the upper surface. The flexible discharge pipe 57 may be connected to the pump discharge by means of internal threads formed in the fitting of the pump discharge (as seen in FIG. 5), which mate with external threads on the discharge pipe. This arrangement acts as a strain relief for the soil load on external discharge plumbing used to connect the system 10 to the sanitary sewer system.

The upper opening 28 in the basin upper portion 14, is adapted generally for two purposes. The first purpose of the opening 28 is to receive an access riser 32, which is adapted to extend to the ground surface from the location of the basin 12 within the ground. This access riser 32 permits the basin 12 to be situated entirely below grade, but with access being maintained to the basin from grade level. The access riser 32 may be a length of standard corrugated polymeric tubing, with a nominal diameter in the range of from about 18 to 24 inches. Because the installed length of the access riser 32 will typically be in the range of from about 1.5 to 7.5 feet, and more typically in the range of from about 2.5 to 6 feet, the length of tubing provided for field installation should be at least the minimum anticipated length. The length of the access riser 32 can then be shortened to the desired length at the installation site, or different lengths can be provided. The standard corrugated tubing that can be used as the access riser 32 will have alternating troughs and crests, with a distance of about 3 inches separating adjacent troughs or adjacent crests from each other. The tubing can be easily cut to a desired length at the field site, such as at a crest or trough of the tube. The access riser 32 could also be of any other suitable configuration, such as a simple cylindrical tube or the like, which also would be easily modified at the field installation site if necessary.

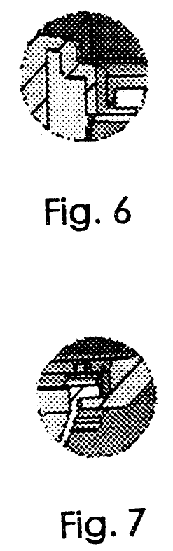

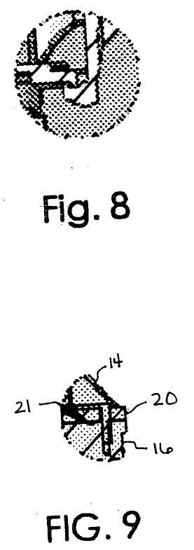

The access riser 32 is selectively coupled to the basin 12 adjacent opening 28 of upper section 14. As seen in FIG. 1, the opening 28 may be formed with an upstanding lip support portion 34, having a diameter somewhat larger than the diameter of opening 28. A compressible seal 36 can be fitted into engagement with the access riser 32, such as in an annular trough of the tube 32. The seal 36 is dimensioned such that forms a friction fitting between the access riser 32 and the upstanding lip portion 34, when the access riser 32 is seated adjacent the upstanding lip portion 34. An open first end of the access riser 32 is supported on a shoulder formed adjacent the lip 34 and opening 28 (see FIG. 6). To further retain the access riser 32 at the position of opening 28, the upstanding lip portion 34 can be dimensioned such that a plurality of fastening members 37, such as screws, can be passed radially through the upstanding lip portion, such that the shank end of each of the screws is positioned into an annular trough of the access riser 32. These fasteners do not need to penetrate the access riser tube surface, but restrict axial movement of the access riser 32 relative to the upstanding lip portion 34 by interference between the fastener shank and the annular crests of the access riser 32. The fasteners 37 may not be necessary, but provide further retention of riser 32 if desired.

In an example of field installation of the grinder pump system, the basin 12 may be positioned in an excavated hole at a desired depth for connection to the sewage source pipe as described previously. The access riser 32 may then be dimensioned to extend to grade, from the position of the basin 12, and attached to the basin 12 by the friction fitting seal 36 and/or other retention members. Alternatively, the access riser 32 may be affixed to the basin 12 in the above manner away from the field installation site, and the assembly positioned such that the access riser 32 extends to grade as desired. Field adjustment of the height of the access riser 32 may be achieved by cutting the length of the access riser 32 prior to assembly with basin 12 or thereafter.

The opening 28 is also adapted to simply install and position the pump components relative to the basin 12. Attention can now be directed to the internal structures of the pump station for understanding of the present invention. In a typical installation, the bottom surface of the installed basin 12 may be at between 4 to 10 feet below grade. In the embodiment as illustrated, and with reference to FIG. 3, the pump station 10 is provided with a pump support and orienting device 40 for positioning the pump 18 in a particular radial orientation, and vertically orienting the pump 18 in the desired position relative to basin 12. In the installed position, the inlet of the pump 18 is suspended near the lowest portion of basin 12 or adjacent the bottom of lower basin portion 16. The outlet 44 of the pump 18 extends upwardly to a height above the interface between the upper and lower basin portions 14 and 16. The pump support 40 provides a means for vertically orienting the pump, and may comprises a generally frustoconical shell having a larger diameter opening 41 at a top end, and a smaller diameter opening 43 at a bottom end. The opening 41 at the top end is adapted for being fixed in place in conjunction with opening 28 of the basin upper portion 14, and as seen in FIG. 7. As an example, the upper end of portion 14 may be provided with threaded inserts extending upwardly, which mate with captive screws provided with a mounting flange formed around the opening 41 at the top of the device 40. Other suitable fastening arrangements are contemplated. It may be desirable to provide a fastening system that requires properly orienting the device 40, and thus the pump 18 mounted therewith. In this manner, the pump-orienting device 40 may be seated and connected in conjunction with opening 28 only in the proper angular alignment that allows the pump discharge to be aligned and mated with the sewage discharge pipe, keeping in mind that this alignment and mating needs to be conducted from the distance between grade and the top of the basin once the pump station is installed. The pump-orienting device 40 thus simplifies installation of the pump 18 with basin 12, and any means of suitably attaching and restraining the pump 18 once installed is contemplated. In addition, the pump-orienting device 40 supports a level control 47, used to monitor the level of effluent in the basin 12, and initiate operation of pump 18 when needed.

The pump 18 may be a two-stage grinder pump having unique characteristics, with further details of this structure are set forth in U.S. Provisional Patent Application Ser. No. 60/511,288, filed Oct. 14, 2003, which is hereby incorporated by reference herein. Further, the pump 18 may have an integrated discharge passage formed with the motor housing of the pump, avoiding the need for additional plumbing and installation requirements. A check valve 48 provided at the discharge outlet to prevent backflow of pumped contents into the system. The check valve 48 may be designed to be integrated with the pump 18, and thus is removable along with the pump, from the pump-orienting device 40. This greatly simplifies maintenance on the check valve 48 if necessary. In the embodiment shown, the check valve 48 is integrated into the pump housing, having a geometry to mate with the discharge outlet. The check valve 48 drops into position easily, making it easily removed with pump 18, for maintenance or the like.

As mentioned above, the ball valve 31 is also conveniently integrated into the system of the pump-orienting device 40. The ball valve 31 is seated into a housing on the device 40, and seals with valve 31 upon installation. The valve 31 may simply be a toggle valve that is dropped into the housing and secured thereto. A harness 59 may be used to toggle the valve 31, extending to the top of riser 32. The valve 31 may then be controlled from the top of the riser 31, without having to access the riser 32 or tank below. If necessary, the valve 31 may be closed to enable removal of the pump 18 for maintenance or repair. For maintenance of the ball valve 31 if necessary, the ball valve 31 may be simply removed along with the device 40.

The integration of the device 40, pump 18, check valve 48 and ball valve 31 together, allow simple and efficient maintenance or access to these components by removing the assemblies. This avoids the need for accessing and working on these components in-situ, as the components can be easily pulled out for repair or replacement. This in turn eliminates the need for confined space access to these components within the system, thereby avoiding the need for certified technicians to perform functions in the access riser. This simplifies maintenance, reduces costs, and provides for a safer system. Further, as access into the riser 32 is not needed, the riser 32 can be reduced in size, resulting in a compact, lower cost system 10.

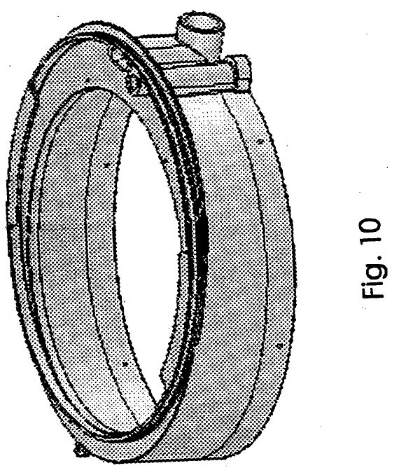

As seen in FIGS. 1, 3 and 10, a riser cap assembly 50 is then provided to close the system 10 to the external environment for safety, and to provide a low profile, aesthetically pleasing outward appearance. The cap assembly 50 may comprise an annular cap adapter member 52 and a lid 54 that may be removably affixed to the open top end of the cap 52. The cap 52 (as seen in FIG. 10), has a sidewall with at least one passage 56 provided so that power and control signal wires, such as direct burial cable with connector 60, for the pump 18 can pass via conduit from the location of the pump 18 inside of the access riser 32 to the external environment. The adapter 52 has an internal diameter somewhat larger than the outside diameter of the access riser 32, especially as measured at one of its crests. A compressible sealing member 53 can be fitted into engagement with the access riser top, such as in association with an annular trough of the access riser 32, again to create a friction fitting between the access riser 32 and the annular adapter 52, when the annular cap is placed atop the access riser 32. The opening at the top end of the adapter 52 may be comparable in diameter to the opening 28 in the basin upper portion 14. The annular cap 52 can further be retained to the access riser 32 by a plurality of fasteners 55, such as screws that are passed radially through the annular cap, such that the shank end of each of the screws is positioned into an annular trough of the access riser 32. The adapter 52 may be dimensioned to overhang a portion of the access riser 32 to allow screws to be positioned to engage the trough below the trough in which the compressible seal member 53 is seated. These fasteners will thus impede axial movement of the adapter 52 relative to the access riser 32. The lid 54 is selectively attached to adapter 52 in any suitable fashion, but as an example, the adapter 52 may have a mounting flange 55 formed at the top thereof, which is adapted to mate with a protrusion on the lid 54 (not shown) to allow the lid 54 to be rotated and locked into place with respect to the adapter 52. This twist lock lid simplifies installation as well as access when necessary. The lid 54 may also be molded or otherwise formed to have the appearance of rock or other natural object, making it aesthetically pleasing when installed. The lid 54 is then selectively removable to allow access to remove the pump assembly, pump orienting device 40 and associated components for maintenance or repair. The use of the pump-orienting device 40, which is easily removable, further simplifies maintenance and/or repair of components integrated therewith, including the level control 47 (FIGS. 1B and 3) and ball valve or shut-off valve 31. This allows maintenance or repair at ground level, rather than down in the riser 32. The pump-orienting device 40 further avoids the need for confined space access to the pump, as required on various prior art constructions.

The foregoing description of an embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A grinder pump system, comprising:
a basin with an interior volume for receiving sewage;
a sewage inlet port in the basin, allowing sewage flow into the basin interior volume;
a sewage discharge port in the basin, allowing sewage to flow out of the system;
an opening in the basin for mounting a pump to extend into the interior volume of the basin,
a pump for processing and pumping of sewage from the basin out the discharge port;
an access riser having a first end thereof selectively seated adjacent said opening in the basin;
a riser cap assembly, removably fitted to an open second end of the access riser; wherein the basin has a shape to urge material therein to a position adjacent the pump inlet.

2. The pump system of claim 1, further comprising:
a device for orienting the pump relative to the basin, said device being removably coupled in association with said opening in the basin.

3. The pump system of claim 2, wherein:
the pump orienting device effectively partitions the basin when installed with a pump, to define the interior volume of the basin.

4. The pump system of claim 2, wherein the device for orienting the pump includes a mounting flange which couples to a flange associated with the basin in a predetermined orientation.

5. The pump system of claim 2, wherein the device for orienting the pump positions the pump both in a predetermined vertical and radial orientation.

6. The pump system of claim 2, wherein the device for orienting the pump allows the pump to be installed therein prior to installation with the basin.

7. The pump system of claim 2, wherein the device for orienting the pump accommodates a check valve associated with the pump, to prevent back flow from the sewage system into the basin interior volume.

8. The pump system of claim 2, wherein the device for orienting the pump supports a ball valve mechanism, used to selectively control operation of the pump system.

9. The pump system of claim 2, wherein:
the device for orienting the pump supports a level controller in the interior volume of the basin.

10. The pump system of claim 1, wherein:
the interior volume of the basin in the lower portion has the shape of an inverted frustocone.

11. The pump system of claim 1, wherein:
an outer surface of the basin comprises a plurality of vertically oriented gussets.

12. The pump system of claim 1, wherein the sewage inlet port comprises a plurality of ports, oriented at different predetermined positions, wherein the plurality of ports are initially sealed, and one or more ports are selected for use upon installation of the pump system.

13. The pump system of claim 12, wherein there are three inlet ports, each positioned orthogonally with respect to an adjacent port.

14. The pump system of claim 1, wherein the riser cap assembly includes an adapter coupled to the access riser, and a lid for access to the interior of the riser.

15. The pump system of claim 14, wherein the lid twist locks into engagement with the adapter.

16. The pump system of claim 14, wherein the lid is formed in the shape and appearance of a natural object.

17. The pump system of claim 1, wherein the discharge port includes a flexible discharge fitting having external threads engaging internal threads on the port, so as to provide strain relief at the coupling to the port.

18. The pump system of claim 1, wherein the basin includes an integral reinforcement mounting structure for positioning of reinforcing members in association therewith.

19. The pump system of claim 2, wherein a ball valve is integrated into the device for orienting the pump, and includes a valve operating mechanism which is operable from a position adjacent the top of the access riser.

20. The pump system of claim 1, wherein the basin includes integral slots for supporting the pump system by means of a forklift or the like.

21. The pump system of claim 1, wherein the access riser is a conventional corrugated pipe sized to be mounted to the opening of the basin.

22. The pump system of claim 21, wherein the corrugated tubing is modified to extend from the basin to substantially ground level upon installation of the pump system.

23. The pump system of claim 1, wherein the basin comprises upper and lower sections which are molded into a desired mating configuration.

24. A grinder pump station, comprising:
a basin with an interior volume for receiving sewage;
the basin having a sewage inlet port to allow sewage flow into the basin interior volume, and a sewage discharge port to allow sewage to flow out of the basin;
an upper opening in the basin for mounting a pump to extend into the interior volume of the basin, and
a pump orienting device for positioning of a pump at a particular orientation relative to the basin for coupling the pump to the discharge port of the basin; wherein the pump orienting device installs with the basin to define the interior volume of the basin when the pump is installed.

25. The pump station of claim 24, wherein:
a lower portion of the basin has a sloped inner wall surface, such that a cross sectional area of the basin generally increases from a bottom of the basin.

26. The pump station of claim 25, wherein:
the interior volume of the basin in the lower portion has the shape of an inverted frustocone.

27. A method of installing a grinder pump station, comprising the steps of:
excavating a well and positioning a basin with an interior volume for receiving sewage therein, at a position below grade; and then performing the following steps without limit to a particular order or sequence,
attaching a source of sewage to a sewage inlet port on the basin, to allow sewage flow into the basin interior volume,
connecting a sewage discharge port on the basin to a sewage line to allow sewage to flow out of the basin;
installing a grinder pump in association with a pump orienting device, and mounting the pump orienting device in an upper opening in the basin, wherein the pump orienting device positions the pump at a particular orientation relative to the basin for coupling the pump to the discharge port of the basin, and to extend into the interior volume of the basin,
forming an access riser with a predetermined height and coupling the access riser to the basin adjacent the upper opening such that the access riser extends to substantially grade, and
positioning a riser cap assembly over an open second end of the access riser to close the system to the outside environment.

28. A method of operating and maintaining a grinder pump system, comprising the steps of:
providing a pump basin with an interior volume for receiving sewage therein, at a position below grade; and a pump positioned relative to the basin within a support device,
providing the support device with an integrated ball valve which is seated into a housing provided on the support device, which seals with the ball valve upon installation,
wherein the ball valve is in fluid communication with the pump when installed in the support device.

29. The method of claim 28, wherein the ball valve is a toggle valve that is connected to a harness that is used to toggle the valve, the harness extending to the top of the pump station so as to be operated adjacent grade level.

30. The method of claim 28, wherein the ball valve is selectively closed to enable removal of the pump for maintenance or repair.

31. The method of claim 28, wherein the ball valve is selectively removable with the pump support device for maintenance or repair.

32. The method of claim 28, further comprising the steps of providing a check valve integral with the pump so as to be removable from the pump support device with the pump for maintenance or repair.

33. The method of claim 32, wherein the check valve integrated into the pump housing, and has a geometry to mate with the discharge outlet.

34. The method of claim 28, wherein a ball valve is integrated into the pump support device, and a check valve is integrated into the pump, wherein the pump support device, pump, check valve and ball valve are each selectively removable from the basin for maintenance or repair, without requirement for confined space access to these components within the basin.

35. The method of claim 34, wherein a riser is coupled to the basin to extend up to grade level, wherein the riser has dimensions which do not allow for confined space access therein.

36. A method of operating and maintaining a grinder pump system, comprising the steps of:
providing a pump basin for receiving sewage at a position below grade, having a grinder system positioned relative thereto for selective pumping of sewage from the basin,
the grinder pump system including serviceable components selected from the group consisting of the pump, a ball valve, a check valve, and a level controller, and
servicing any serviceable components at a position above grade.
